(19) United States
(12) Patent Application Publication
(10) Pub. No.: US 2021/0031341 A1
(43) Pub. Date: Feb. 4, 2021

(54) ELECTRIC SCREWDRIVER WITH TORQUE ADJUSTMENT AND SENSING FUNCTION

(71) Applicant: PRODRIVES & MOTIONS CO., LTD., TAIPEI CITY (TW)

(72) Inventors: YUN-LUN CHANG, TAIPEI CITY (TW); CHIH-CHENG CHOU, TAIPEI CITY (TW); YUEH-YANG HU, TAIPEI CITY (TW)

(21) Appl. No.: 16/666,381

(22) Filed: Oct. 28, 2019

(30) Foreign Application Priority Data
Aug. 1, 2019 (TW) 108210132

(51) Int. Cl. B25B 23/147; B25B 23/142; G01L 5/24; B25B 21/00; G01L 5/00; F16H 3/44

(52) U.S. Cl. CPC B25B 23/147; B25B 23/1425; G01L 5/24; B23B 2270/48; G01L 5/0042; F16H 3/44; B25B 21/00

(57) ABSTRACT

This invention provides an electric screwdriver with an integrated torque adjustment and sensing function, comprising a torque sensor connected between an electric motor and a torque adjuster. The torque sensor comprises a transmission shaft connected to the motor shaft by the shaft, a torque sensing component and at least one planetary gear set. The planetary gear set has a torque output component. The transmission shaft transmits the speed reduced rotational force through the torque output component to drive the output shaft to output a target torque which can be adjusted by the adjuster. The torque sensing component senses the operating torque between the transmission shaft and the torque output component of the torque sensor, thereby assembling to improve the problem that the conventional electric screwdriver can only adjust but cannot accurately sense the operating torque.

### FIELD OF THE INVENTION

The present invention relates to the structure of an electric screwdriver, more particularly to an electric screwdriver that has both torque adjustment and sensing function.

### DESCRIPTION OF RELATED ART

An electric screwdriver or an electric screw driver is an electric hand tool that relies on an electric motor to provide a rotational driving force to drive a shaft member to output rotational kinetic energy. It is commonly used in equipment with specific torque fastening requirements or torque tightening for products or tools with safety considerations. The target torque of the electric screwdriver is used to tight the screws.

A conventional electric screwdriver generally has a speed reducer and a torque adjuster in addition to an internal electric motor. The speed reducer is connected in-series between the electric motor and the torque adjuster to reduce the output speed of the electric motor and to increase the torque value transmitted to the torque adjuster. The torque adjuster is used to provide a usage of the electric screwdriver to a user by which the electric screwdriver can be adjusted to meet the different requirements of the target torque required for screw tightening to adjust the amount of the target torque output from the electric screwdriver so that the screw can be properly tightened.

A torque adjuster conventionally mounted on an electric screwdriver is a clutch type torque adjuster that uses a knob exposed on the outer surface of the electric screwdriver for the user to turn the knob to adjust the compression length of the compression spring inside. The output shaft is pressed by the compression spring to engage with the input shaft, when the compressing force is large enough, the torque can be transmitted. The output shaft disengages from input shaft when compressed force is smaller than the applied torque from output shaft. According to the description above, we can adjust the knob to change the compressed force of the compression spring to further setup the target torque we want to apply to the screws.

However, since the compressed force of the compression spring output is elastically fluctuating, and adjusting knob that the user can setup can only be used to roughly confirm the value of the torque of the electric screwdriver output, it is impossible to accurately determine the amount of the torque that is actually output when the screw is locked, and therefore needs to be improved.

### SUMMARY OF THE INVENTION

In view of the fact that the conventional electric screwdriver cannot accurately sense the output torque to be adjusted by the torque regulator contained therein, the present invention provides an electric screwdriver that combines the torque adjustment and the sensing function.

To meet this end, the electric screwdriver with torque adjustment and sensing function provided by the present invention comprising:

an electric motor for outputting a rotational force by a motor shaft;

a torque sensor comprising a transmission shaft that engages rotational force of a motor shaft, a torque sensing component and at least one planetary gear set for speed reducing purpose, the planetary gear set comprising a force output component through which the rotational force being transmitted by the transmission shaft after deceleration; and

a torque adjuster comprising a force input shaft and a force output shaft that can be coupled and separated from each other, the force input shaft being coupled to the torque output component, and the force input shaft and the force output shaft being coupled via a clutch, and a torque output by the force output shaft being controlled by the clutch mutually coupled between the force input shaft and the force output shaft via a spiral compression spring;

wherein the torque sensing component is located between the transmission shaft of the torque sensor and the force output component to sense the output target torque of the force output shaft of the torque adjuster.

According to the present invention, the planetary gear set comprises a first stage planetary gear set and a second stage planetary gear set, a torque input end and a force output end is respectively formed at the both ends of the transmission shaft, the transmission shaft is coupled to the rotational force of the motor shaft via the torque input end and the first stage planetary gear set, the force output component is disposed in the second stage planetary gear set, and the transmission shaft transmits the rotational force after deceleration to force output component via the force output end.

According to the present invention, the first stage planetary gear set comprises a first stage sun gear fixed to the motor shaft, and a plurality of the first stage sun gears surrounding and engaging a periphery of first stage planetary sun gear, for the first stage planetary gear set the torque input end of the transmission shaft is used as a first stage planetary carrier being pivoted to the first stage planetary gear set.

According to the present invention, the second stage planetary gear set comprises: a second stage sun gear fixed on the force output end of the transmission shaft, a second stage ring gear located on a periphery of the second stage sun gear, and a plurality of second stage planetary gears interposed and engaging between the second stage ring gear and the second stage sun gear.

According to the present invention, the motor shaft, the transmission shaft, the force input shaft and the force output shaft are located on the same axial center line.

According to the present invention, the second stage planetary carrier of the plurality of second stage planetary gears is used as the force output component.

According to the present invention, the second stage ring gear is rotated by the sum of the circumferential forces generated when the plurality of second stage ring gears are engaged by the second stage planetary gears.

According to the present invention, the torque sensing component is composed of a strain gauge attached to at least one shrapnel, and the torque adjuster comprises a housing comprising the built-in transmission shaft, the torque sensing component and the second stage planetary gear set, and wherein a fixing disk is fixed in the housing, and the shrapnel attached with the strain gauge is connected to a relatively eccentric position between the fixing disk and the second stage ring gear, for the torque sensing component the fixing disk is used as a fixed end, and for the torque sensing component the second stage ring gear is used as a movable end for sensing the torque.

According to the present invention, a plurality of bolt holes are respectively spaced apart and disposed at the fixing disk toward outer peripheral of the housing, bolts are respectively inserted, bolt head at one end of the bolt is restrained in the bolt hole, and the bolt bar at the other end of the bolt penetrates into the radial wall surface of the fixing disk to fix the fixing disk in the housing of the torque sensor.

According to the present invention, the second stage ring gear is used as the force output element.

According to the present invention, each of the at least one shrapnel generates a bending deformation, the strain gauge is subjected to bending deformation to generate a strain, and the strain is used as a basis for sensing the output torque.

According to the present invention, the spiral compression spring applies a pressing force to keep the force output shaft and the force input shaft being coupled to each other, the torque adjuster further comprises a knob having a given amount of thread advancing path, and the spiral compression spring receives the pushing force from the knob, and adjusts the value of the pressing force applied by the spiral compression spring via the knob.

In another preferred embodiment of the present invention, the second stage ring gear is used as the force output element.

According to the present invention, the second stage planetary gear set further comprises a second stage planetary carrier for pivoting the plurality of second stage planetary gears, the second stage planetary carrier is rotated by a rotation angle by a circumferential force generated by the plurality of second stage planetary gears.

According to the present invention, the spiral compression spring applies a pressing force to keep the force output shaft and the force input shaft being mutually connected, and the torque adjuster further comprises a knob for having a given amount of thread advancing path, the spiral compression spring receives the push of the knob and adjusts the pressing force applied by the spiral compression spring via the knob.

According to the present invention, the torque sensing component is composed of a strain gauge attached to at least one resilient member, and the torque adjuster comprises a housing comprising the built-in transmission shaft, the torque sensing component and the second stage planetary gear set, and wherein a fixing disk is fixed in the housing, and the resilient member attached with the strain gauge is connected to a relatively eccentric position between the fixing disk and the second stage ring gear, the eccentric position of the second stage ring gear is such that the at least one resilient member is seated on the periphery of the transmission shaft and parallel to the axial direction of the transmission shaft.

In the above implementation of the present invention, the motor shaft, the transmission shaft, the force input shaft, and the force output shaft may be disposed on the same axial center line.

According to the above technical means of the present invention, the performance that the present invention can be as follows:

1. On the basis of the conventional electric screwdriver that has the clutch type torque adjuster, the new type of electric screwdriver of the present invention is combined with the torque sensor, which promotes the electric screwdriver not only has the function of adjusting the output torque, but also it is equipped with the function of sensing and outputting, so that the controller can record the precise value of the output torque, which is convenient for the operator to determine the correctness of the output torque during fastening, so as to perfect the use requirement.

2. With the force output end of the torque sensor and the force input shaft of the clutch in the torque adjuster used as the shaft interface, the actual output torque of the torque adjuster can be accurately sensed.

In addition, the relevant technical details that can be implemented by the present invention will be explained in the following embodiments and drawings.

### BRIEF DESCRIPTION OF THE DRAWINGS

FIG. 1 is a plan cross-sectional view of the first embodiment of the present invention using a ring gear to sense output torque;

FIG. 2 is a perspective assembled view of the internal components of the torque sensor of FIG. 1 of the present invention;

FIG. 3 is a plan cross-sectional view of the plane of FIG. 1 of the present invention;

FIG. 4 is a plan, fragmentary cross-sectional view of the second embodiment of the present invention utilizing the planetary carrier to sense the output torque.

### DETAILED DESCRIPTION OF THE PREFERRED EMBODIMENT

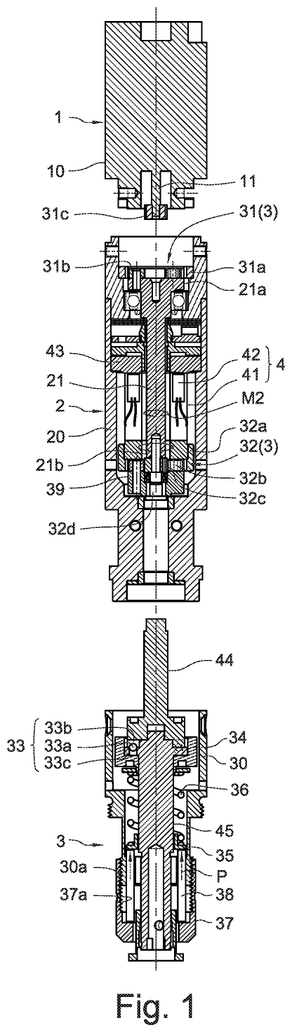

Firstly, please refer to FIG. 1 to FIG. 3 of the present invention to disclose the first embodiment of the present invention, which utilizes a ring gear to sense the output torque, and the electric screwdriver comprises an electric motor 1, a torque sensor 2, and a torque adjuster 3.

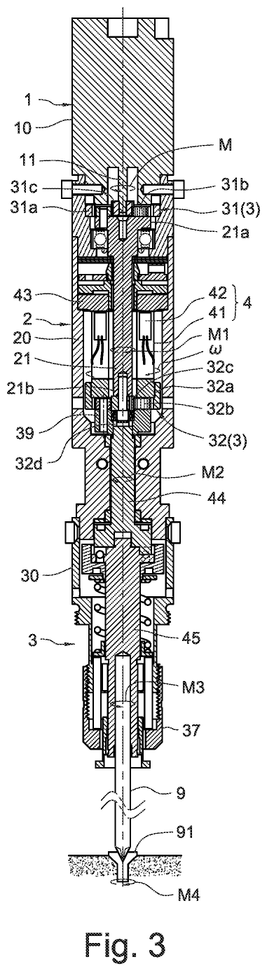

It can be seen from FIG. 1 and FIG. 3 of the present invention that the torque sensor 2 has a hollow annular housing 20, and the both ends of the housing 20 are respectively connected to the outer shell 10 of the electric motor 1 and the base shell 30 of the torque adjuster 3, to be assembled into this new type of electric screwdriver with protection and torque adjustment and torque sensing function of the present invention.

Further, the torque sensor 2 of the present invention comprises a transmission shaft 21 and at least a planetary gear set for speed reducing purpose pivotally disposed in the housing 20. The planetary gear set in the present embodiment comprises a first stage planetary gear set 31 and a second planetary gear set 32. The transmission shaft 21 has a torque input end 21a and a torque output end 21b. The torque input end 21a is driven by the torque origin M via the first stage planetary gear set 31. Thus, the torque of M is amplified by the first stage with speed reduced into M1, and the first stage speed reduced torque M1 drives the second stage planetary gear set 32 to output a second stage speed reduced torque M2 of output end 21b (described later).

Please refer to FIG. 1 to FIG. 3, which discloses that the first stage planetary gear set 31 comprises a first stage ring gear 31a fixed inside on the housing 20, and a plurality of first stage planetary gears 31b engaged with the first stage ring gears 31a and a first stage sun gear 31c fixed to the motor shaft 11. The first stage sun gear 31c is in the center of the plurality of first stage planetary gears 31b. The torque input end 21a of the transmission shaft 21 is formed with a disk shape for use as a planetary gear carrier of the plurality of first stage planetary gears 31b, in other words, the plurality of first stage planetary gears 31b equally spaced away on the circumferential end portion is pivotally disposed at the torque input end 21a of the transmission shaft 21. Therefore, when the motor shaft 11 outputs the torque M, the torque M can be transmitted to the plurality of first stage planetary gears 31b via the first stage sun gear 31c to perform the speed reducing of the first stage reduction ratio and the increasing of the amount of torque output (i.e., the torque M1 after the first stage speed reducing), thereby enabling the plurality of first stage planetary gears 31b to be rotated by the first stage speed reduced torque M1 to make the transmission shaft 21 rotate.

The second stage planetary gear set 32 of the present invention is disposed at the torque output end 21b of the transmission shaft 21, and comprises a second stage sun gear 32c fixed to the torque output end 21b and a second stage planetary gears in the periphery of sun gear 32c, a second stage ring gear 32a disposed at a periphery of the second stage sun gear 32c and capable of properly rotating by itself, a plurality of second stage planetary gears 32b meshed between the second stage ring gear 32a and the second stage sun gear 32c, and a torque output component 39.

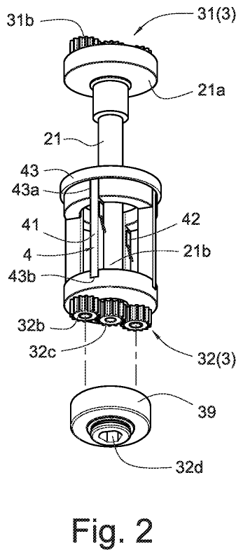

In the present embodiment of the present invention, the torque output component 39 can be formed with a disk-shaped planetary carrier (as shown in FIG. 2) to be an end surface for the plurality of second stage planetary gears 32b to be equally and circumferentially spaced apart from the torque output component 39 so as to be used as a planetary carrier for the second stage planetary gear set 32. In addition, at the center of the torque output component 39 a shaft hole 32d is formed. The shaft hole 32d can be implemented as a bolt groove, a socket or a thread groove, etc., so as to be coupled to the torque adjuster 3.

It should be noted that in the present invention when the transmission shaft 21 outputs the speed reduced torque M1 through the first stage planetary gear set 31, the second stage sun gear 32c which pivotally fixed with the transmission shaft 21 will output a secondary speed reduced torque M2 from M1 by meshing with the plurality of second stage planetary gears 32b via the torque output component 39 (as shown in FIG. 3). When the plurality of second stage planetary gears 32b revolute, the second stage ring gear 32a provides an equal circumferential guiding effect on the plurality of second stage planetary gears 32b.

Further, as shown in FIG. 3 of the present invention, during the revolving process of the plurality of second stage planetary gears 32b, the second stage ring gear 32a engaged by the plurality of second stage planetary gears 32b receives a sum of the circumferential force such that the second stage ring gear 32a can also be slightly rotated with a rotation angle ω under appropriate restraint as a medium for sensing the torsion (as explained in details later).

Further, as shown in FIGS. 1 to 2 of the present invention, a torque sensing component 4 is disposed in the housing 20 of the torque sensor 2. The torque sensing component 4 may be a shrapnel 41. A strain gauge 42 is attached to the upper portion of the shrapnel 41, and the torque sensing component 4 is disposed in the housing 20 between the transmission shaft 21 and the torque output component 39.

In order to properly configure the torque sensing component 4, a fixing plate 43 is fixed in the housing 20 of the torque sensor 2, and a through hole or a pivot hole is formed in the center of the fixing plate 43 for the transmission shaft 21 to pass through. A plurality of engaging slots 43a annularly spaced away and eccentrically located at an eccentric position are disposed on a side disk surface of the fixing plate 43 (as shown in FIG. 2). Furthermore, at one end side of the second stage ring gear 32a corresponding to the engaging slot 43a is also provided with a plurality of embedded joints 43b (shown in FIG. 2) which are annularly spaced and located at an eccentric position, so that a plate-like shrapnel 41 is respectively disposed between the corresponding engaging slots 43a and the embedded joints 43b and so that the torque sensing component 4 can be fixed in the housing 20 with the fixing disk 43 used as a fixed end. For the torque sensing component 4 the second stage ring gear 32a is used as an active end for sensing the torque. In a further implementation, the torque sensing component 4 and the second stage ring gear 32a may be integrally designed or press-fitted.

In this way, a plurality of plate-like shrapnels 41 of the present invention can be disposed in the housing 20 at a time, and the plurality of shrapnels 41 can be radially (or radially) spaced apart and fixed at one end and movable at the other end and arranged at an eccentric position on the periphery of the transmission shaft 21 at intervals. Each of the shrapnel 41 is parallel to the axial direction of the transmission shaft 21, thereby, the middle portion of the body of at least one of the plurality of shrapnels 41 can be utilized to attach the strain gauges 42 so that one of the plurality of shrapnels 41 of the torque sensor 2 can generate a bending deformation during the transmission of the rotational force.

In fact, in order to facilitate assembly and reduce the number of components, the plurality of shrapnels 41 may be integrally formed on the end side of the fixing disk 43 to avoid the arranging of the engaging slot 43a. Alternatively the plurality of shrapnels 41 may be integrated to be formed on the opposite end sides of the second stage ring gear 32a, and eliminating the arranging of the embedded joint 43b in a feasible embodiment.

As shown in FIG. 1 and FIG. 3, the torque adjuster 3 comprises an force input shaft 44 and a force output shaft 45 which are connected to and separated from each other in a hollow annular base shell 30 so that the motor shaft 11, the transmission shaft 21, the force input shaft 44 and force the output shaft 45 can be located on the same axial line. The force input shaft 44 and the force output shaft 45 are axially connected via a clutch 33. The clutch 33 is used as medium of coupling and separating the rotational force between the force input shaft 44 and the force output shaft 45. The force input shaft 44 can be inserted into the housing 20 of the torque sensor 2 to be axially coupled to the torque output component 39 via the shaft hole 32d, so that the torque adjuster 3 can connect the rotational torque M2 outputted from the speed reduction of the torque sensor 2.

Further, in FIG. 1, it is disclosed that the end portion for coupling the force input shaft 44 and the shaft hole 32d is formed with an annular wave-shaped slot disk surface 33b. The output shaft 45 is to be inserted into the corresponding end portion of the force input shaft 44 to form an annular bead disk 33c for accommodating one or more balls 33a, and the clutch 33 is composed of the disk surface 33b, the balls 33a, and the bead disk 33c. In addition, the bead disk 33c of the force output shaft 45 is disposed on the periphery of the force output shaft 45 and actively sleeved with a spring seat 34 coupled to the combined pad, and a spring pusher holder 35 is actively sleeved and disposed on the periphery of the force output shaft 45 spaced apart by a spring length, so that a spiral compression spring 36 is disposed on the periphery of the force output shaft 45 between the spring seat 34 and the spring pusher holder 35.

In addition, the base shell 30 is provided with a knob 37 at a position away from the end of the force input shaft 44. A plurality of push pins 38 are accommodated in the eccentric annular interval of the knob 37, so that the axial direction of the push pins 38 is parallel to the force output shaft 45. One end of each push pin 38 can receive the push of the knob 37 and move along its axial direction to push the spring pusher holder 35 to move. Further, the end portion of the base casing 30 for engaging the knob 37 by a screw is formed with an annular outer thread 30a, and the internal thread 37a is formed in the knob 37. The outer thread 30a and the internal thread 37a are connected to each other by threading such that the knob 37 can adjust its position on the base shell 30 via the thread advancement amount, thereby pushing the plurality of push pins 38 to press the spring pusher holder 35 to move.

In view of this, the operator can manually adjust the position of the knob 37 to drive the plurality of push pins 38 to press the spring pusher holder 35 to move, and then push the spiral compression spring 36 via the spring pusher holder 35 and to adjust the value of the pressing force P exerted by the spiral compression spring 36 on the spring seat 34, so as to control the value of the force and the timing when the bead disk 33c, the balls 33a and the disk surface 33b (i.e., the clutch 33) are coupled to transmit or separated to disengage the rotational force.

According to the above configuration, as shown in FIG. 3, the operator can adjust an target torque M3 output by the electric screwdriver from the force output shaft 45 via the knob 37 for tightening a construction member 91 of the outside (for example, a screw or a nut, etc), and within the range in which the knob 37 can be rotated, under the condition that the output torque M3 is equal to or smaller than the rotational force M2.

When the force output shaft 45 of the electric screwdriver is assembled with the screwdriver rod 9 for tightening the construction member 91, especially when the construction member 91 is tightened, the force output shaft 45 will withstand a reaction load M4 from the construction member 9, and the amount of reaction load M4 is larger than the target torque M3, and then it resists the pressing force P of the spiral compression spring 36. At this time, the clutch 33 instantaneously separates the force input shaft 44 from the force output shaft 45, and stops the electric motor 1.

The target torque M3 can be measured via the strain gauge 42 attached to the shrapnel 41. Further, when the operator activates the electric motor 1 to drive the force output shaft 45 to rotate, since the fixing disk 43 in the torque sensor 2 is stationary, in comparison to the second stage ring gear 32a it is acceptable that the plurality of the second stage ring gears 32a mesh and rotate to have a degree of freedom of suitable revolving, thus the plurality of shrapnels 41 disposed between the fixing disk 43 and the second stage ring gear 32a can be connected to the end of the fixing disk 43 as a fixed end, and connecting the end of the second stage ring gear 32a as the slightly movable end so that the restrained second stage ring gear 32a can drive the plurality of shrapnels 41 to generate bending deformation at the moment when the circumferential force of the second stage planetary gear 32b is applied on second stage ring gear 32a. At this moment, the strain gauge 42 attached to the shrapnel 41 can be synchronously subjected to bending deformation to generate strain E, which can be signal transmitted to the control unit of the electric screwdriver (not shown).

Further, the electric screwdriver of the present invention can sensitively measure the output torque by reading the signal from the strain gauge 42 attached to the shrapnel 41 at the moment of tightening of the power tool component (i.e., amount of the reaction load M4 is larger than that of the target torque M3). The maximum value Mmax of the output torque M3 is recorded. In other words, the maximum value Mmax of the output torque M3 is the current operating torque M3 value of the tightening construction member 91 so that the operator can easily adjust the required target torque through the torque adjuster 3. The target torque M3 is made to determine the correctness of the target torque M3. In the conventional technology, the above-mentioned target torque M3 cannot be accurately measured. However, the present invention can accurately measure the value of the operating torque M3 via the intervening configuration of the torque sensor 2.

Further, in order to cope with the adjustment of the speed reducing ratio, the above-described implementation may be converted so that the torque input end 21a of the transmission shaft 21 of the torque sensor 2 is directly coupled to the motor shaft 11 without the first stage planetary gear set 31 being mounted. In other words, the torque sensor 2 only needs to transmit the speed reduced rotational force by the second stage planetary gear set 32, and the purpose of detecting the output torque of the electric screwdriver can also be achieved.

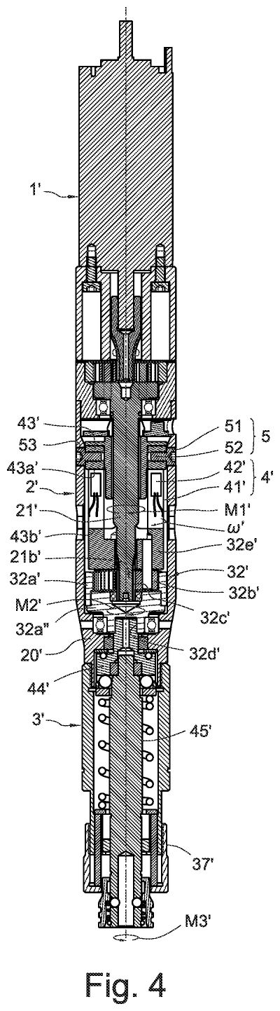

Please refer to FIG. 4, which discloses a second embodiment of the present invention, which utilizes a planetary carrier to sense the output torque, and illustrates a series of torque sensors 2′ combined between an electric motor 1′ and a torque adjuster 3′ which are similar in structure. The biggest difference from the above-mentioned first embodiment, in that in the second stage planetary gear set 32′ of the torque sensor 2 the planetary carrier 32e′ is not used as the force output element, on the contrary the planetary carrier 32e′ is used as the force output element 32a′, while each of the shrapnels 41′ of the torque sensing member 4′ is mounted by the second stage planetary carrier 32e′. The second stage planetary carrier 32e′ can serve as the movable end of each of the shrapnels 41′ for sensing the output torque M3′, except for the difference in assembly, the other structures are substantially the same, identical and equivalent as in the first embodiment.

Further, the second stage planetary carrier 32e′ is formed in a disk shape, and a through hole or a pivot hole is formed in the center thereof for the transmission shaft 21′ to pass through. The second stage planetary carrier 32e′ is formed and pivoted between the plurality of second stage planetary gears 32b′ and the plurality of shrapnels 41′.

The end disk surface of the second stage planetary carrier 32e′ is provided with a plurality of embedded joints 43b′ which are annularly spaced and located at an eccentric position, and the positions of the embedded joints 43b′ correspond to the engaging slot 43a′ on the fixing disk 43′, so that the shrapnel 41′ to which the strain gauge 42′ is attached can be fixed between the corresponding engaging slot 43a′ and the embedded joint 43b′ so that when the output torque M3 ‘ is sensed, the fixing disk 43’ can be used as the fixed end, and the second stage planetary carrier 32e′ is used as the movable end. Further, the plurality of second stage planetary gears 32b′ are pivotally disposed at an equal circumferential eccentric position of the other disk end of the second stage planetary carrier 32e′.

Having been implemented in this manner, particularly during the transmission of rotational force, the plurality of second stage planetary gears 32b′ can apply a rotational force M1′ while mesh with the second stage sun gear 32c′ as the force output end 21b′ of the transmission shaft 21′, it is sequentially restrained by the fixing disk 43′ (fixed end) via the second stage planetary carrier 32e′ and the plurality of shrapnels 41′, so that the plurality of second stage planetary gear 32b′ will only rotate in place, and will not freely revolve around the second stage sun gear 32c′. More precisely, the plurality of second stage planetary gears 32b′ do not freely revolve around the second stage sun gear 32c′, but generate circumferential force to drive the second stage planetary carrier 32e′ (active end) to rotate by a rotation angle ω′ and to enable the plurality of shrapnels 41′ to respectively generate a bending deformation, thereby causing the strain gauge 42′ to generate a strain E′ to sense the output torque M3′.

Meanwhile, the second stage ring gear used as the force output element 32a′ can generate the second stage speed reduced torque M2′ via the engagement of the plurality of second stage planetary gears 32b's. One end of the second stage ring gear (force output element 32a′) can be tightly integrated or integrated with a disk component 32a″. The shaft hole 32d′ in the first embodiment is formed at the center of the disk component 32a″ in order to use the shaft hole 32d′ to axially connect the force input shaft 44′ of the torque adjuster 3′, to adjust the required target torque M3′ via the knob 37′, and to output torque M3′ from the force output shaft 45′ to tight the construction components.

In addition, in the above two embodiments of the present invention, the embodiment in which the fixing plates 43, 43′ are fixed in the housings 20, 20′ of the torque sensor is actually fastened by the bolts 5. Further, as shown in the second embodiment of FIG. 4, it is disclosed that a plurality of bolt holes 53 are spaced apart from the peripheral housing 20′ of the fixing disk 43′. The bolt 5 is inserted into the bolt hole 53 so that the bolt head 51 of the bolt 5 is restrained in the bolt hole 53, and the bolt bar 52 of the bolt 5 is inserted into the radial wall surface of the fixing disk 43′, thereby fixing the fixing disk 43′ into the housing 20′ of the torque sensor. In this way, the most economical structural assembly means can be achieved, and the fixation of the degree of freedom of the bidirectional uniform beam fixing plate 43′ can be achieved in the axial direction of the transmission shaft 21′ and in the direction of the circumferential rotation of the fixing disk 43′, so that the bending deformation of the plurality of shrapnels 41′ in the torque sensing component 4′ can be more stably generated, thereby making the strain gauge 42′ more sensitive to generate the strain E′, so as to accurately sense the output torque M3′. Furthermore, the bolt 5 can be replaced by a common fixing component such as a positioning tip or a positioning pin in the case where the locking position is constant, which is a technical scope that can be applied to the present invention.

The above embodiments are merely illustrative of the preferred embodiments of the present invention, but are not to be construed as limiting the scope of the present invention. Therefore, the present invention is subject to the content of the claims defined in the scope of the patent application.

We claim:

1. An electric screwdriver with torque adjustment and sensing function comprising:
an electric motor for outputting a rotational force by a motor shaft;
a torque sensor comprising a transmission shaft that engages rotational force of a motor shaft, a torque sensing component and at least one planetary gear set for speed reducing purpose, the planetary gear set comprising a torque output component through which the rotational force being transmitted by the transmission shaft after deceleration; and
a torque adjuster comprising a force input shaft and a force output shaft that can be coupled and separated from each other, the force input shaft being coupled to the torque output component, and the force input shaft and the force output shaft being coupled via a clutch, and a torque outputted by the force output shaft being controlled by the clutch mutually coupled between the force input shaft and the force output shaft via a spiral compression spring;
wherein the torque sensing component is located between the transmission shaft of the torque sensor and the force output component to sense the outputted torque of the force output shaft of the torque adjuster.

2. The electric screwdriver according to claim 1, wherein the planetary gear set comprises a first stage planetary gear set and a second stage planetary gear set, a torque input end and a force output end is respectively formed at the both ends of the transmission shaft, the transmission shaft is coupled to the rotational force of the motor shaft via the torque input end and the first stage planetary gear set, the torque output component is disposed in the second stage planetary gear set, and the transmission shaft transmits the rotational force after speed reduced to torque output component via the force output end.

3. The electric screwdriver according to claim 2, wherein the first stage planetary gear set comprises a first stage sun gear fixed to the motor shaft, and a plurality of the first stage sun gears surrounding and engaging a periphery of first stage planetary sun gear, for the first stage planetary gear set the torque input end of the transmission shaft is used as a first stage planetary carrier being pivoted to the first stage planetary gear set.

4. The electric screwdriver according to claim 2, wherein the second stage planetary gear set comprises: a second stage sun gear fixed on the force output end of the transmission shaft, a second stage ring gear located on a periphery of the second stage sun gear, and a plurality of second stage planetary gears interposed and engaging between the second stage ring gear and the second stage sun gear.

5. The electric screwdriver according to claim 4, wherein the motor shaft, the transmission shaft, the force input shaft and the force output shaft are located on the same axial center line.

6. The electric screwdriver according to claim 5, wherein a second stage planetary carrier of the plurality of second stage planetary gears is used as the torque output component.

7. The electric screwdriver according to claim 6, wherein the second stage ring gear is rotated by the sum of the circumferential forces generated when the plurality of second stage ring gears are engaged by the second stage planetary gears.

8. The electric screwdriver according to claim 7, wherein the torque sensing component is composed of a strain gauge attached to at least one shrapnel, and the torque adjuster comprises a housing comprising the built-in transmission shaft, the torque sensing component and the second stage planetary gear set, and wherein a fixing disk is fixed in the housing, and the shrapnel attached with the strain gauge is connected to a relatively eccentric position between the fixing disk and the second stage ring gear, for the torque sensing component the fixing disk is used as a fixed end, and for the torque sensing component the second stage ring gear is used as a movable end for sensing the torque.

9. The electric screwdriver according to claim 8, wherein a plurality of bolt holes are respectively spaced apart and disposed at the fixing disk toward outer peripheral of the housing, bolts are respectively inserted, bolt head at one end of the bolt is restrained in the bolt hole, and the bolt bar at the other end of the bolt penetrates into the radial wall surface of the fixing disk to fix the fixing disk in the housing of the torque sensor.

10. The electric screwdriver according to claim 5, wherein the second stage ring gear is used as the force output element.

11. The electric screwdriver according to claim 10, wherein the second stage planetary gear set further comprises a second stage planetary carrier for pivoting the plurality of second stage planetary gears, the second stage planetary carrier is rotated by a rotation angle by a circumferential force generated by the plurality of second stage planetary gears.

12. The electric screwdriver according to claim 11, wherein the torque sensing component is composed of a strain gauge attached to at least one shrapnel, and the torque adjuster comprises a housing for containing the transmission shaft, the torque sensing component and the second stage planetary gear set, and wherein a fixing disk is fixed in the housing, and the shrapnel attached with the strain gauge is connected to a relatively eccentric position between the fixing disk and the second stage ring gear, for the torque sensing component the fixing disk is used as a fixed end, and for the torque sensing component the second stage ring gear is used as a movable end for sensing the torque.

13. The electric screwdriver as claimed in claim 12, wherein a plurality of bolt holes are respectively spaced apart and disposed at the fixing disk toward outer peripheral of the housing, bolts are respectively inserted, bolt head at one end of the bolt is restrained in the bolt hole, and the bolt bar at the other end of the bolt penetrates into the radial wall surface of the fixing disk to fix the fixing disk in the housing of the torque sensor.

14. The electric screwdriver according to claim 1, wherein the spiral compression spring applies a thrust to drive the force output shaft and the force input shaft to be mutually connected, and the torque adjuster further comprises a knob for having a given amount of thread advancing path, the spiral compression spring receives the push of the knob and adjusts the pressing force applied by the spiral compression spring via the knob.
